(19) United States
(12) Patent Application Publication
(10) Pub. No.: US 2014/0339932 A1
(43) Pub. Date: Nov. 20, 2014

(54) ELECTRIC MACHINE INCLUDING A THERMAL CONTROL MODULE

(71) Applicant: REMY TECHNOLOGIES, L.L.C., Pendleton, IN (US)

(72) Inventors: Noman Hossain, Fort Wayne, IN (US); Anthony Trzaska, Carmel, IN (US)

(73) Assignee: REMY TECHNOLOGIES, L.L.C., Pendleton, IN (US)

(21) Appl. No.: 13/894,917

(22) Filed: May 15, 2013

(51) Int. Cl. H02K 9/00

(52) U.S. Cl. CPC H02K 9/005
USPC 310/53; 165/267

(57) ABSTRACT

An electric machine includes a stator. The stator includes a stator core, and a plurality of windings supported by the stator core. The plurality of windings include a first end turn portion and a second end turn portion. An adaptable cooling system is fluidically connected to the housing. The adaptable cooling system includes a first coolant circuit configured to guide a coolant in a heat exchange relationship with the stator core, and a second coolant circuit configured to guide a coolant in a heat exchange relationship with one of the first and second end turn portions. A thermal control module is operably connected to the adaptable cooling system. The thermal control module includes a coolant demand schedule described in a machine specific coolant map and is configured and disposed to selectively adapt coolant delivery to the first and second coolant circuits based on the coolant demand schedule

### BACKGROUND OF THE INVENTION

Exemplary embodiments pertain to the art of electrical machines and, more particularly, to an electric machine having a thermal control module.

Many electric machines include cooling systems. The cooling systems take on various forms and are configured to reduce operating temperatures of the electric machine to extend component service life or provide enhancement to peak power ratings. Electric motors often times will include a cooling system having a rotor or armature driven fan. The fan guides a cooling fluid through the electric motor to dissipate heat. Other cooling systems include passing a fluid through a coolant jacket that surrounds a portion of the electric machine and direct spraying of coolant onto one or more internal components of the electric machine.

### BRIEF DESCRIPTION OF THE INVENTION

Disclosed is an electric machine including a housing having an outer surface and an inner surface. A stator is fixedly mounted to the inner surface. The stator includes a stator core, and a plurality of windings supported by the stator core. The plurality of windings includes a first end turn portion and a second end turn portion. An adaptable cooling system is fluidically connected to the housing. The adaptable cooling system includes a first coolant circuit configured to guide a coolant in a heat exchange relationship with the stator core, and a second coolant circuit configured to guide a coolant in a heat exchange relationship with one of the first and second end turn portions. A thermal control module is operably connected to the adaptable cooling system. The thermal control module includes a coolant demand schedule described in a machine specific coolant map and is configured and disposed to selectively adapt coolant delivery to the first and second coolant circuits based on the coolant demand schedule.

Also disclosed is a thermal control module for an electric machine. The thermal control module includes a coolant map having a coolant demand schedule for the electric machine. The controller is configured and disposed to control coolant delivery to the electric machine based on the coolant demand schedule.

Further disclosed is an electric machine including a housing having an outer surface and an inner surface. A stator fixedly mounted to the inner surface. The stator includes a stator core, and a plurality of windings supported by the stator core. The plurality of windings includes a first end turn portion and a second end turn portion. A rotor is arranged within the housing and rotatably mounted relative to the stator. An adaptable cooling system is fluidically connected to the housing. The adaptable cooling system includes a first coolant circuit configured to guide a coolant in a heat exchange relationship with the stator core, and a second coolant circuit configured to guide a coolant in a heat exchange relationship with the rotor. A thermal control module includes a coolant demand schedule described in a machine specific coolant map and is operably connected to the adaptable cooling system. The thermal control module is configured and disposed to selectively adapt coolant delivery to the first and second coolant circuits based on the coolant demand schedule.

Still further disclosed is an electric machine including a housing having an outer surface and an inner surface. A stator fixedly mounted to the inner surface. The stator includes a stator core, and a plurality of windings supported by the stator core. The plurality of windings includes a first end turn portion and a second end turn portion. A rotor is arranged within the housing and rotatably mounted relative to the stator. An adaptable cooling system is fluidically connected to the housing. The adaptable cooling system includes a first coolant circuit configured to guide a coolant in a heat exchange relationship with one of the first and second end turn portions, and a second coolant circuit configured to guide a coolant in a heat exchange relationship with the rotor. A thermal control module includes a coolant demand schedule described in a machine specific coolant map and is operably connected to the adaptable cooling system. The thermal control module is configured and disposed to selectively adapt coolant delivery to the first and second coolant circuits based on the coolant demand schedule.

Yet still further discloses is an electric machine including a housing including an outer surface and an inner surface and a stator fixedly mounted to the inner surface. The stator includes a stator core, and a plurality of windings supported by the stator core. The plurality of windings includes a first end turn portion and a second end turn portion. A rotor is arranged within the housing and rotatably mounted relative to the stator. An adaptable cooling system is fluidically connected to the housing. The adaptable cooling system includes a first coolant circuit configured to guide a coolant in a heat exchange relationship with the stator core, and a second coolant circuit configured to guide a coolant in a heat exchange relationship with one of the first and second end turn portions. A thermal control module is operably connected to the adaptable cooling system. The thermal control module is configured and disposed to selectively adapt coolant delivery to the first and second coolant circuits based on coolant temperature at an outlet of at least one of the first and second coolant circuits.

### BRIEF DESCRIPTION OF THE DRAWINGS

The following descriptions should not be considered limiting in any way. With reference to the accompanying drawings, like elements are numbered alike:

FIG. 1 depicts an electric machine including an adaptive cooling system in accordance with an exemplary embodiment;

FIG. 2 depicts a chart illustrating a coolant map describing a motor cooling demand schedule of the electric machine in FIG. 1;

FIG. 3 depicts an electric machine including an adaptive cooling system in accordance with another aspect of an exemplary embodiment; and

FIG. 4 depicts a flow chart illustrating a method of cooling the electric machine of FIG. 1.

### DETAILED DESCRIPTION OF THE INVENTION

A detailed description of one or more embodiments of the disclosed apparatus and method are presented herein by way of exemplification and not limitation with reference to the Figures.

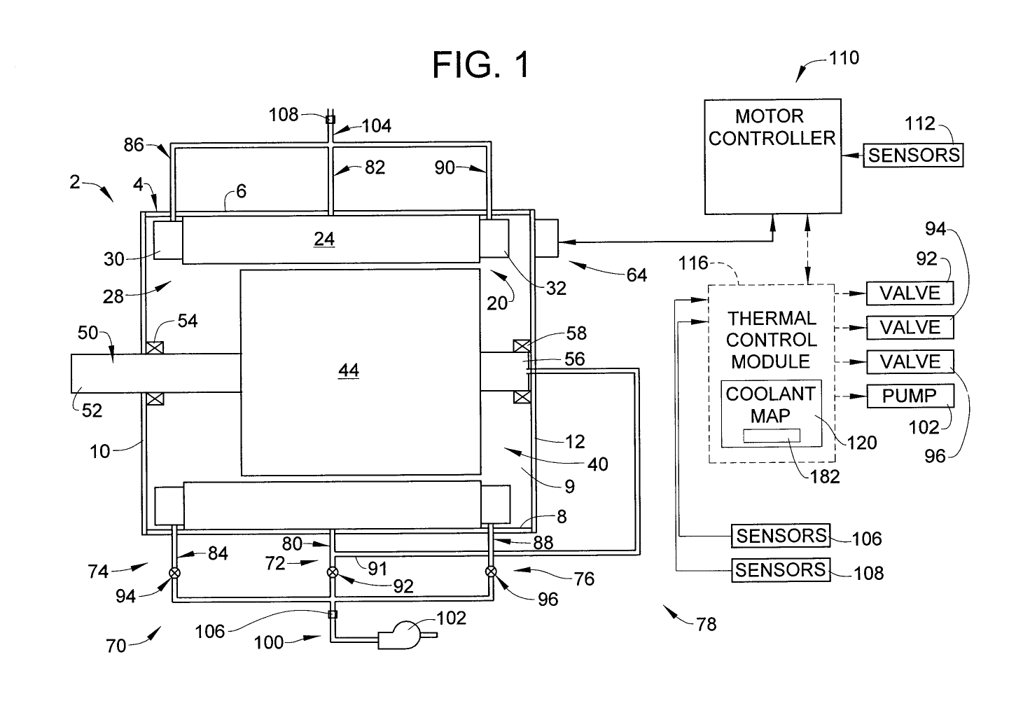

An electric machine in accordance with an exemplary embodiment is indicated generally at 2 in FIG. 1. Electric machine 2 is shown in the form of an electric motor having a housing 4 including an outer surface 6 and an inner surface 8 that defines an interior portion 9. Housing 4 also includes a first end wall 10 and an opposing, second end wall 12. At least one of end walls 10 and 12 may be removable to provide access to interior portion 9. Electric machine 2 is also shown to include a stator 20 arranged in interior portion 9. Stator 20 includes a stator core 24 fixedly mounted to interior surface 8. Stator core 24 supports a plurality of stator windings 28 that include a first end turn portion 30 and a second end turn portion 32.

Electric machine 2 is also shown to include a rotor assembly 40 including a rotor body 44 supported by a shaft 50. Rotor body 44 can take on a variety of forms and many include windings and/or permanent magnets. Shaft 50 includes a first end 52 supported at first end wall 10 through a first bearing 54, and a second end 56 supported at second end wall 12 through a second bearing 58. It should be understood that rotor assembly 40 should not be limited to being supported at both ends of shaft 50. Rotor body 44 may also be supported in a cantilevered fashion from one of first and second end walls 10 and 12. Electric machine 2 is also shown to include a terminal block 64 that provides an interface between windings 28 and external electrical sources or loads.

In accordance with an aspect of the exemplary embodiment, electric machine 2 includes an adaptive cooling system 70. Adaptive cooling system 70 includes a first coolant circuit 72, a second coolant circuit 74, a third coolant circuit 76, and a fourth coolant circuit 78. First coolant circuit 72 includes an inlet portion 80 that passes a coolant in a heat exchange relationship with stator core 24 and an outlet portion 82 that guides the coolant from housing 4. It should be understood that coolant can be passed through a jacket (not shown) formed in housing 4 in a heat exchange relationship with stator core 24 or may be passed through passages formed in stator core 24. Other mechanisms for exchanging heat between the coolant and the stator core may also be employed.

Second coolant circuit 74 includes a first inlet section 84 that delivers coolant toward first end turn portion 30 and a first outlet section 86 that guides coolant from housing 4. Similarly, third coolant circuit 76 includes a second inlet section 88 that passes a coolant toward second end turn portion 32 and a second outlet section 90 that guides the coolant from housing 4. The coolant may be passed in a heat exchange relationship with first and second end turn portions 30 and 32 through a variety of delivery systems including both direct and indirect contact with windings 28. Fourth cooling circuit 78 is shown connected in parallel with first cooling circuit 72 and delivers cooling fluid through rotor 44. More specifically, fourth cooling circuit 78 includes a rotor inlet section 91 that is fluidly connected to inlet portion 80 and rotor 44 through shaft 50. Fourth cooling circuit 78 also includes a cooling fluid outlets (not shown) provided on an outer periphery of rotor 44. The cooling fluid outlet allow coolant to pass from rotor 44 and pass to first outlet section 86 and/or third outlet section 90.

Adaptive cooling system 70 is also shown to include a first valve 92 arranged in inlet portion 80, a second valve 94 arranged in first inlet section 84, and a third valve 96 arranged in second inlet section 88. Adaptive cooling system 70 is further shown to include an inlet 100 fluidically connected to inlet portion 80 and first and second inlet sections 84 and 88. Inlet 100 is also fluidically connected to a pump 102 that delivers coolant into selected ones of first coolant circuit 72, second coolant circuit 74, third coolant circuit 76 and fourth coolant circuit 78. An outlet 104 is fluidically connected to outlet portion 82, and first and second outlet sections 86 and 90. Outlet 104 may deliver the coolant to a heat exchanger (not shown) and back to inlet 100 or to another system (also not shown).

In accordance with an aspect of the exemplary embodiment inlet 100 includes an inlet temperature sensor 106 and outlet 104 includes an outlet temperature sensor 108. Inlet temperature sensor 106 is arranged to sense a temperature of coolant flowing into inlet 100 and outlet temperature sensor 108 is arranged to sense a temperature of coolant flowing through outlet 104. At this point it should be understood that although cooling circuit 78 is shown connected in parallel with cooling circuit 72 in FIG. 1, and therefore also controlled by valve 92, it is also understood that cooling circuit 78 could be connected to inlet 100 having a separate valve (not shown). With such an arrangement, cooling circuit 78 could be controlled independently of cooling circuit 72. Electric machine 2 is also shown to include a motor controller 110. Motor controller 110 receives sensed operational parameters of the motor from sensors 112. Sensors 112 are configured to detect one or more operating parameters such as current draw, rotor speed, rotor torque and/or voltage. Motor controller 110 defines and measures operational parameters of electric machine 2. Motor controller 110 also. includes, or is operably connected with, a thermal control module 116. Thermal control module 116 is operably connected with input temperature sensor 106, output temperature sensor 108 and valves 92, 94 and 96.

At lower speeds, up to about base speed of electric machine 2, it may be more desirable to reduce I²R or copper losses at first and second end turn portions 30 and 32. In such cases, valves 92, 94 and 96 are selectively controlled to deliver more coolant to second and third coolant circuits 74 and 76 than that being delivered to first coolant circuit 72 and fourth coolant circuit 78. Thermal control module 116 may also be configured to detect other parameters of electric machine 2 to determine how changes in coolant delivery affect performance. Thermal control module 116 may then store information to create a machine specific temperature map for electric machine 2. Thermal control module 116 may then employ the machine specific temperature map to control positions of valves 92, 94 and 96 to enhance machine operation across all speed and torque ranges.

In addition to the above, thermal control module 116 monitors coolant inlet temperature and coolant outlet temperature through inlet temperature sensor 106 and outlet temperature sensor 108. Based on the coolant inlet temperature and coolant outlet temperature, thermal control module 116 signals pump 102 to adjust coolant flow rate through adaptive cooling system 70. More specifically, thermal control module 116 may signal pump 102 to reduce coolant flow rate when temperatures are below a predetermined threshold in order to reduce power requirements for the system and enhance overall system efficiency.

At this point it should be understood that thermal control module 116 may be embedded in motor controller 110 or may be a separate component that may connect with motor controller 110. If a separate component, thermal control module 116 may be offered as an accessory that may be integrated into existing electric machines without requiring extensive modification. Further, while illustrated as being linked to sensors 106 and 108, and valves 92, 94 and 96, thermal control module 116 may include integrated valves and sensors that control cooling flow within an associated electric machine.

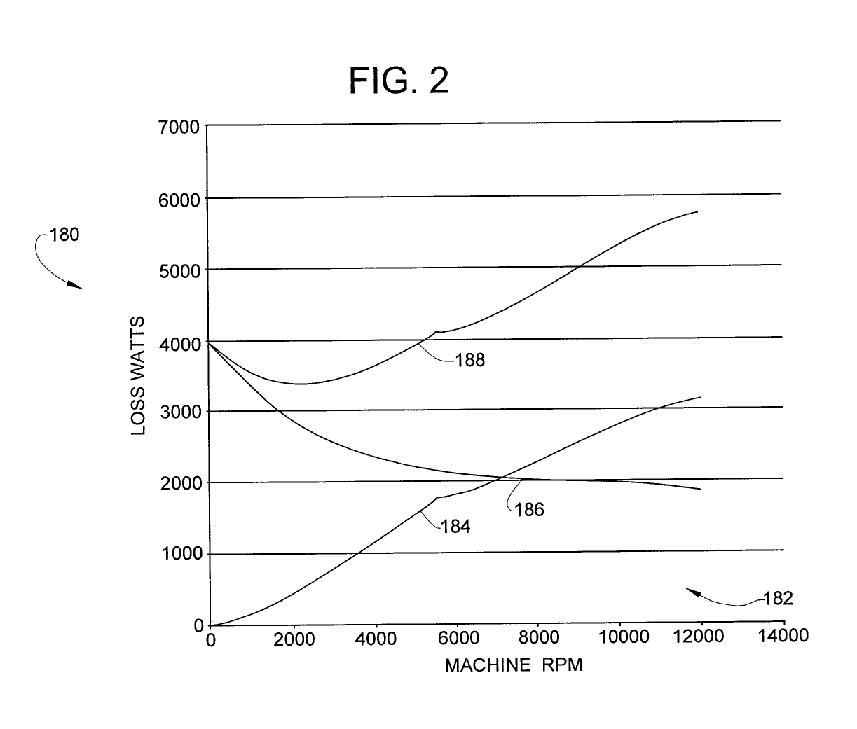

More specifically, thermal control module 116 includes a coolant map 120 describing a motor cooling demand schedule 182, illustrated in FIG. 2, that correlates operating speed to losses in stator 24 or iron losses 184 and loses in stator windings 28 or copper losses 186 as well as combined losses 188. Coolant map 120 and associated motor cooling demand schedules are developed during development of electric machine 2. As will be discussed more fully below, thermal control module 116 controls coolant flow through electric machine 2 based on coolant map 120. At lower speeds, up to about base speed of electric machine 2, it may be more desirable to reduce I²R or copper losses 186 at first and second end turn portions 30 and 32. In such cases, first, second, and third valves 92, 94 and 96 are selectively controlled to deliver more coolant to second and third coolant circuits 74 and 76 than that being delivered to first coolant circuit 72 and fourth coolant circuit 78. At higher speeds, it may be more desirable to reduce iron losses 184. In such a case, first, second, and third valves 92, 94 and 96 are selectively controlled to deliver more coolant to first coolant circuit 72 and fourth coolant circuit 74 that is delivered to second and third coolant circuits 74 and 76. In short, thermal control module 116 relies on coolant map 120 to determine cooling demand and coolant flow through electric machine 2.

At this point it should be understood that thermal control module 116 may be embedded in motor controller 110 or may be a separate component that may connect with motor controller 110. If a separate component, thermal control module 116 may be offered as an accessory that may be integrated into existing electric machines without requiring extensive modification. Further, while illustrated as being linked to valves 92, 94 and 96, thermal control module 116 may include integrated valves that control cooling flow within an associated electric machine.

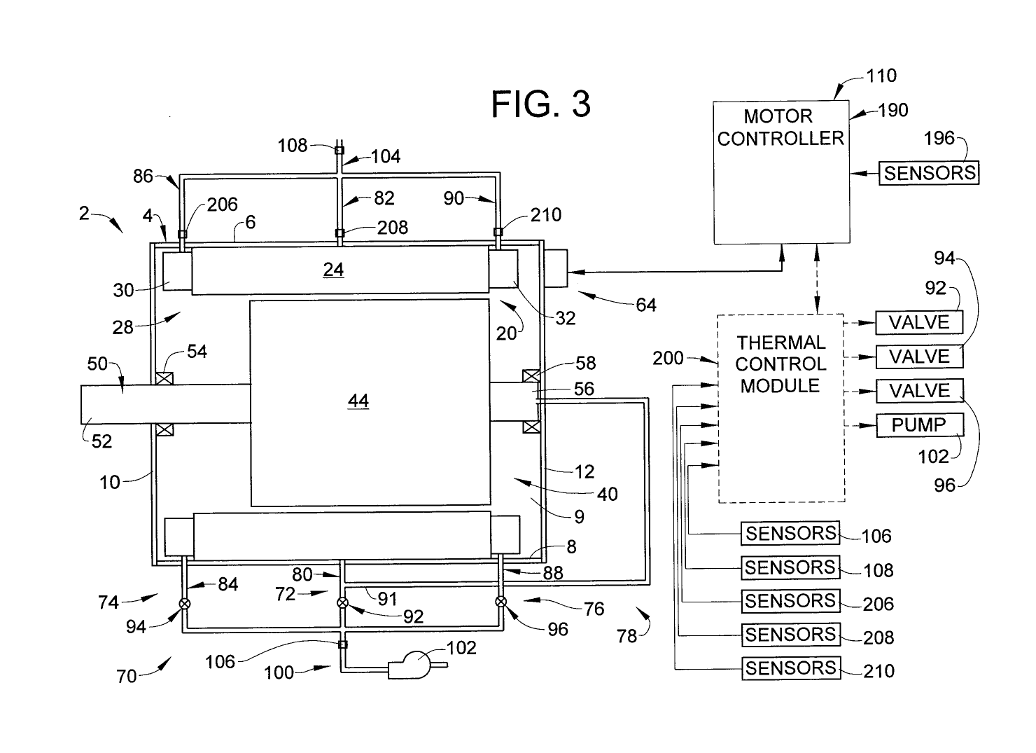

Reference will now be made to FIG. 3, wherein like reference numbers represent corresponding parts in the respective views in describing a motor controller 190 in accordance with another aspect of the exemplary embodiment. Motor controller 190 receives sensed operational parameters of the motor from sensors 196. Sensors 196 are configured to detect one or more operating parameters such as current draw, rotor speed, rotor torque and/or voltage. Motor controller 190 is linked to a thermal control module 200. Thermal control module 200 is connected to inlet temperature sensor 106, outlet temperature sensor 108 as well as valves 92, 94 and 96. Input from sensors 146 is passed to thermal control module 200 which in turn, may control (based on the value of input sensors 146) valves 92, 94 and 96 to adapt coolant delivery through respective ones of first, second, third and/or fourth coolant circuits 72, 74, 76 and/or 78 to reduce operating temperatures and improve machine performance. In the exemplary embodiment shown, thermal control module 200 is operatively connected to a first outlet temperature sensor 206 positioned at fluid return circuit 90, a second outlet temperature sensor 208 positioned at coolant return circuit 82, and a third outlet temperature sensor 210 positioned at coolant return circuit 86.

Thermal control module 200 receives input signals from outlet temperature sensors 206, 208 and 210 indicating, for example, higher heat rejection in one coolant return branch in relation to another. Based on the signals from one or more of outlet temperature sensors 206, 208 and 210, thermal control module 200 controls coolant delivery to first, second, third and fourth coolant circuits 72, 74, 76, and 78 by adjusting the rate of flow in each circuit. For example, temperature at outlet temperature sensor 208 may indicate a need for more cooling at stator core 24 than currently required for first and second end turn portions 30 and 32. In such a case, valves 92, 94, 96 are selectively controlled to deliver more coolant to first coolant circuit 72 and fourth coolant circuit 78 than that being delivered to second and third coolant circuits 74 and 76. Thermal control module 200 may also be configured to detect other parameters of electric machine 2 to determine how changes in coolant delivery affect performance. Thermal control module 200 may then store information in its memory to create an improved and optimized temperature map specific to a particular machine and or duty cycle.

In addition to the above, thermal control module 200 monitors coolant inlet temperature and coolant outlet temperature through inlet temperature sensor 106 and outlet temperature sensors 206, 208 and/or 210. Based on the coolant inlet temperature and coolant outlet temperature(s), thermal control module 200 signals pump 102 to adjust coolant flow rate through adaptive cooling system 70. More specifically, thermal control module 200 may signal pump 102 to reduce coolant flow rate when temperatures are below a predetermined threshold in order to reduce power requirements for the system and enhance overall system efficiency.

At this point it should be understood that thermal control module 200 may be embedded in motor controller 190 or may be a separate component that may connect with motor controller 190. If a separate component, thermal control module 200 may be offered as an accessory that may be integrated into existing electric machines without requiring extensive modification. Further, while illustrated as being linked to valves 92, 94 and 96, thermal control module 200 may include integrated valves that control cooling flow within an associated electric machine.

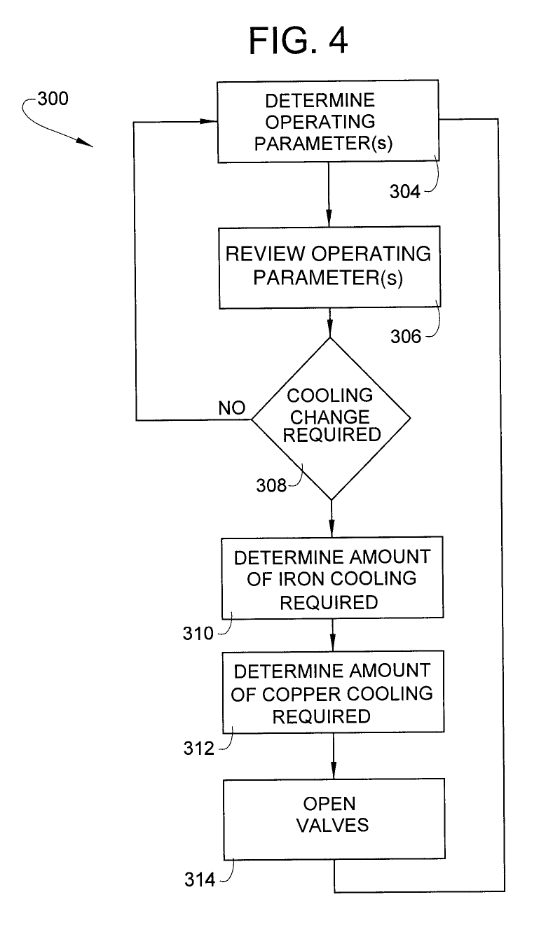

Reference will now be made to FIG. 4 in describing a method 300 of operating electric machine 2 in accordance with an exemplary embodiment. Motor controller 110 initially determines one or more operating parameters of electric machine 2 in block 304. The operating parameters may include operating speed, operating current, operating torque and/or voltage or coolant temperature at inlet 100, outlet portion 82, first outlet section 86 and/or second outlet section 90. The operating parameter(s) are passed to thermal control module 116/200 for review. In accordance with an aspect of the exemplary embodiment, thermal control module 116/200 may compare the operating parameters with the machine specific coolant map) 120 or simply adjust coolant flow based on coolant temperature in block 306. A cooling demand is determined in block 308 based on cooling parameters associated with the operating parameters. If no cooling or change in cooling is required, the operating parameter(s) continue to be monitored. If a cooling change is indicated, an amount of iron cooling is determined in block 310 and an amount of cooper cooling desired is determined in block 312. At this point, thermal control module 116 selectively opens one or more of valves 92, 94, and/or 96 to direct coolant through one or more of the first, second, third, and/or fourth coolant circuits 72, 74,76, and/or 78 as indicated in block 314 and operating parameters then continue to be monitored.

At this point it should be understood that the exemplary embodiments provide a system or systems for selectively delivering coolant to portions of an electric machine. Coolant flow to particular components can be selectively tailored to address real time operating conditions. In this manner, additional coolant flow can be channeled to a component that may need increased heat removal to enhance overall performance of the electric machine. By selectively controlling coolant flow, the cooling system size can be reduced. More specifically, the cooling system need not be designed to accommodate maximum cooling demand for all components. Cooling demand for components of an electric machine vary during operation. As discussed above, during high speed operation, the stator core may benefit from additional cooling to reduce iron losses while the end turn portions may not require as much cooling. Conversely, during low speed operation up to base speed operation, the end turn portions may benefit from additional cooling to reduce I²R or copper losses which the stator core may not require as much cooling.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing including an outer surface and an inner surface;
a stator fixedly mounted to the inner surface, the stator including a stator core, and a plurality of windings supported by the stator core, the plurality of windings including a first end turn portion and a second end turn portion;
a rotor arranged within the housing and rotatably mounted relative to the stator;
an adaptable cooling system fluidically connected to the housing, the adaptable cooling system including a first coolant circuit configured to guide a coolant in a heat exchange relationship with the stator core, and a second coolant circuit configured to guide a coolant in a heat exchange relationship with one of the first and second end turn portions; and
a thermal control module including a coolant demand schedule described in a machine specific coolant map operably connected to the adaptable cooling system, the thermal control module being configured and disposed to selectively adapt coolant delivery to the first and second coolant circuits based on the coolant demand schedule.

2. The electric machine according to claim 1, wherein the first coolant circuit includes an inlet portion configured to lead coolant to the housing and an outlet portion configured to lead coolant out from the housing, and the second coolant circuit includes an inlet section configured to lead coolant to the housing and an outlet section configured to lead coolant from the housing.

3. The electric machine according to claim 2, further comprising: a first valve arranged in the inlet portion and a second valve arranged in the inlet section, the thermal control module being operably connected to each of the first and second valves.

4. The electric machine according to claim 3, further comprising: a motor controller operatively connected to the electric machine and the thermal control module, the motor controller including at least one sensor configured and disposed to detect an operational parameter of the electric machine and operably connected to the thermal control module.

5. The electric machine according to claim 4, wherein the at least one sensor comprises one of a speed sensor, a current sensor, a voltage sensor and a torque sensor.

6. The electric machine according to claim 3, further comprising: at least one temperature sensor operatively connected to the thermal control module.

7. The electric machine according to claim 1, further comprising: a third coolant circuit configured to guide a coolant in a heat exchange relationship with the other of the first and second end turn portions.

8. The electric machine according to claim 7, further comprising: a fourth coolant circuit configured to guide a coolant to the rotor.

9. The electric machine according to claim 8, wherein the fourth coolant circuit is fluidically connected in parallel with the first coolant circuit.

10. The electric machine according to claim 1, wherein the coolant map is stored in the thermal control module.

11. The electric machine according to claim 1, further comprising: an inlet fluidically connected to the first and second coolant circuits and an outlet fluidically connected to the first and second coolant circuits, the inlet including an inlet temperature sensor configured and disposed to detect a temperature of coolant flowing into the first and second coolant circuits and the outlet including an outlet temperature sensor configured and disposed to detect a temperature of coolant flowing out from the first and second coolant circuits, each of the inlet temperature sensor and the outlet temperature sensor being operatively connected to the thermal control module.

12. A thermal control module for an electric machine comprising:
a coolant map including a coolant demand schedule for the electric machine, the controller being configured and disposed to control coolant delivery to the electric machine based on the coolant demand schedule.

13. The thermal control module according to claim 12, wherein the thermal control module is operatively connected to one or more sensors configured and disposed to detect an operating parameter of the electric machine.

14. The thermal control module according to claim 13, wherein the one or more sensors comprise temperature sensors configured and disposed to detect temperatures in a stator of an electric machine.

15. The thermal control module according claim 13, wherein the one or more sensors comprise at least one of a current sensor, a speed sensor, a torque sensor and a voltage sensor.

16. The thermal control module according to claim 12, wherein the thermal control module is operatively connected to one or more valves configured and disposed to control coolant delivery through the electric machine.

17. The thermal control module according to claim 12, wherein the coolant map is directly associated with the electric machine.

18. An electric machine comprising:
a housing including an outer surface and an inner surface;
a stator fixedly mounted to the inner surface, the stator including a stator core, and a plurality of windings supported by the stator core, the plurality of windings including a first end turn portion and a second end turn portion;
a rotor arranged within the housing and rotatably mounted relative to the stator;
an adaptable cooling system fluidically connected to the housing, the adaptable cooling system including a first coolant circuit configured to guide a coolant in a heat exchange relationship with the stator core, and a second coolant circuit configured to guide a coolant in a heat exchange relationship with the rotor; and
a thermal control module including a coolant demand schedule described in a machine specific coolant map operably connected to the adaptable cooling system, the thermal control module being configured and disposed to selectively adapt coolant delivery to the first and second coolant circuits based on the coolant demand schedule.

19. An electric machine comprising:
a housing including an outer surface and an inner surface;
a stator fixedly mounted to the inner surface, the stator including a stator core, and a plurality of windings supported by the stator core, the plurality of windings including a first end turn portion and a second end turn portion;
a rotor arranged within the housing and rotatably mounted relative to the stator;
an adaptable cooling system fluidically connected to the housing, the adaptable cooling system including a first coolant circuit configured to guide a coolant in a heat exchange relationship with one of the first and second end turn portions, and a second coolant circuit configured to guide a coolant in a heat exchange relationship with the rotor; and
a thermal control module including a coolant demand schedule described in a machine specific coolant map operably connected to the adaptable cooling system, the thermal control module being configured and disposed to selectively adapt coolant delivery to the first and second coolant circuits based on the coolant demand schedule.

20. An electric machine comprising:
a housing including an outer surface and an inner surface;
a stator fixedly mounted to the inner surface, the stator including a stator core, and a plurality of windings supported by the stator core, the plurality of windings including a first end turn portion and a second end turn portion;
a rotor arranged within the housing and rotatably mounted relative to the stator;
an adaptable cooling system fluidically connected to the housing, the adaptable cooling system including a first coolant circuit configured to guide a coolant in a heat exchange relationship with the stator core, and a second coolant circuit configured to guide a coolant in a heat exchange relationship with one of the first and second end turn portions; and
a thermal control module operably connected to the adaptable cooling system, the thermal control module being configured and disposed to selectively adapt coolant delivery to the first and second coolant circuits based on coolant temperature at an outlet of at least one of the first and second coolant circuits.
